(19) United States
(12) Patent Application Publication
(10) Pub. No.: US 2021/0376316 A1
(43) Pub. Date: Dec. 2, 2021

(54) POROUS TIN FOIL ANODE, A METHOD FOR PREPARING THE SAME AND A SODIUM ION SECONDARY BATTERY

(71) Applicant: REAL POWER INDUSTRIAL LIMITED COMPANY, Shenzhen (CN)

(72) Inventors: Yongbing TANG, Shenzhen (CN); Chengde XIE, Shenzhen (CN); Maohua SHENG, Shenzhen (CN)

(73) Assignee: REAL POWER INDUSTRIAL LIMITED COMPANY, Shenzhen (CN)

(21) Appl. No.: 16/963,844

(22) PCT Filed: Dec. 29, 2016
(86) PCT No.: PCT/CN2016/113284

§ 371 Date: Jul. 22, 2020

(51) Int. Cl. H01M 4/38; H01M 4/583; H01M 4/04; H01M 10/054; H01M 4/66; H01M 4/80

(52) U.S. Cl. CPC H01M 4/387; H01M 4/583; H01M 4/0433; H01M 2004/021; H01M 4/661; H01M 4/663; H01M 4/80; H01M 10/054

(57) ABSTRACT

A porous tin foil anode includes a porous tin foil. A plurality of holes are uniformly formed on the porous tin foil. A triangular area formed by lines connecting centers of three adjacent holes is used as a smallest unit. The proportion of the area of the holes in each smallest unit is 1%-89%. The distance between the edge of the porous tin foil and the hole is 0.1 mm-10 mm. The porous tin foil anode can be applied to a sodium ion battery system that uses tin foil as both a current collector and an anode active material, which effectively solves the problem of battery expansion and alleviates the problem of decomposition of the solid electrolyte membrane during the charge and discharge process of the battery. The short circuiting that occurs because of burrs on the tin foil puncturing the separator is also eliminated.

### CROSS REFERENCE TO THE RELATED APPLICATIONS

This application is the national phase entry of International Application No. PCT/CN2016/113284, filed on Dec. 29, 2016, the entire contents of which are incorporated herein by reference.

### TECHNICAL FIELD

The present invention relates to the technical field of sodium ion secondary batteries, and more particularly, to a porous tin foil anode, a method for preparing the porous tin foil anode and a sodium ion secondary battery.

### BACKGROUND

In 2016, the Shenzhen Institute of Advanced Technology of the Chinese Academy of Sciences made a breakthrough in the research on novel high-efficiency batteries and developed a novel aluminum-graphite dual-ion battery technology. The research results were published in “Advanced Energy Materials” (DOI: 10.1002/aenm.201502588). This novel high-efficiency battery system uses aluminum foil as the anode. The aluminum foil acts as both a current collector and an anode active material, thus reducing the use of conventional anode active materials. The new aluminum foil based system has high specific energy density, low cost and promising application prospects.

Meanwhile, the Institute conducted in-depth research on dual-ion batteries and proposed the tin-graphite dual-ion battery technology. This battery uses graphite as the cathode and tin foil as both the anode active material and the current collector. The battery is operated on the premise that sodium and tin are alloyed and de-alloyed during the charge and discharge process of cation sodium and tin. Anions are intercalated and de-intercalated into graphite. Although the use of conventional anode active materials is reduced, this novel high-efficiency battery system exhibits high specific energy density and is less expensive. Using tin foil as anodes, however, has drawbacks such as anode pulverization as a result of the volume expansion (112%) caused by the alloying of tin and sodium. Another problem is the electrode-electrolyte compatibility during the charge and discharge process of the tin foil. This affects the charge-discharge efficiency and the cycle and safety performances of the battery.

### SUMMARY

In order to solve the above-mentioned problems, the first aspect of the present invention provides a porous tin foil anode. The porous tin foil anode can be applied in a novel battery system that uses tin foil as both a current collector and an anode active material. This effectively solves the problem of battery expansion and alleviates the problem of decomposition of the solid electrolyte membrane during the charge and discharge process of the battery. The short circuiting that occurs because of burrs on the tin foil puncturing the separator is also eliminated. The charge and discharge efficiency and cycle and safety performances of the battery are also significantly improved as a result.

The first aspect of the present invention provides a porous tin foil anode, including a porous tin foil. A plurality of holes are uniformly formed on the porous tin foil. A triangular area formed by lines connecting centers of three adjacent holes is used as a smallest unit. The proportion of the area of the holes in each smallest unit is 1%-89%. The distance between the edge of the porous tin foil and the outermost hole is 0.1 mm-10 mm. In the present invention, the porous tin foil of the porous tin foil anode acts as both a current collector and an anode active material.

The coating uniformity and consistency of the active material of the battery electrodes are critical to the electrical performance and safety performance of the battery. It is, therefore, necessary to accurately control the coating uniformity of the cathode and anode active materials during manufacture of the battery. It also is necessary to accurately control the uniformity of the porous tin foil in the novel sodium ion battery system that uses porous tin foil as both the current collector and the anode active material. Thus, whether the porous tin foil can be used as both the anode active material and the current collector particularly depends on the size of the porous tin foil and the distribution uniformity of the holes. In the present invention, optionally, the proportion of the area of the holes in each smallest unit is 25%-60%. In the present invention, optionally, each smallest unit has an equal proportion of the area of the holes.

The proportion of the area of the holes in the smallest unit determines the volume expansion that the porous tin foil anode can withstand due to lithium intercalation, and thus can be set based on the proportion of the area of the porous tin foil anode that respectively acts as a current collector and an active material in the pre-designed battery. Specifically, the sodium ions are intercalated in tin foil to form a tin-sodium alloy resulting in a volume expansion of 112%. Therefore, in the present invention, the reserved space is designed according to the double volume change rate when tin and sodium are alloyed. In other words, in a pre-designed battery, if the proportion of the area of the porous tin foil anode acting as the active material in the smallest unit is 20% and the proportion of the area of the porous tin foil anode acting as the current collector in the smallest unit is 20%-57%, then the proportion of the area of the holes in the smallest unit is preferably set to 23%, or larger than 23%, e.g., 23%-60%, thus providing the reserved space for the volume change caused by the formation of the sodium-tin alloy as a result of the intercalation of the sodium ions into the tin foil.

Currently, when the large-sized porous tin foil obtained by mechanical processing is cut into electrodes, a large number of burrs are generated on the edge of the tin foil due to the damage to the hole. When the tin foil is encapsulated into a battery, the burrs on the tin foil may puncture the separator inducing a short circuit, which affects the battery performance. In the present invention, a certain distance is reserved at the edge of the porous tin foil anode without arranging holes, which can effectively prevent the formation of rough edges and burrs and improve the stability and safety of the battery. In the present invention, optionally, the distance between the edge of the porous tin foil and the outermost hole is 2 mm-5 mm.

In the present invention, an isosceles triangular area formed by lines connecting the centers of three adjacent holes in two adjacent rows in the porous tin foil is used as the smallest unit. Each smallest unit has an equal proportion of the area of the holes. Further, optionally, any two adjacent holes in the horizontal direction have an equal distance, and any two adjacent holes in the vertical direction have an equal distance.

Optionally, the distance between any two adjacent holes in the horizontal direction is equal to the distance between any two adjacent holes in the vertical direction. Optionally, the distance between any two adjacent holes in the horizontal direction is equal to the distance between two adjacent rows.

Optionally, the size of the holes of the porous tin foil is 20 nm-2 mm. Further, the size of the holes of the porous tin foil is 50 μm-1.5 mm. Further, preferably, the holes have an equal size.

In the present invention, the shape of the plurality of holes of the porous tin foil can be one selected from the group consisting of a circle, an oval, a square, a rectangle, a rhombus, a triangle, a polygon, a pentagram, and a quincunx. It should be understood that the shape is not limited to the above shapes. A large side length of the hole can facilitate the intercalation of sodium ions.

In the present invention, the surface of the porous tin foil is provided with a carbon material layer. Optionally, the material of the carbon material layer includes at least one selected from the group consisting of hard carbon, soft carbon, conductive carbon black, graphene, a graphite flake and a carbon nanotube, and the thickness of the carbon material layer is 2 nm-5 μm. Further, the thickness of the carbon material layer is 200 nm-3 μm.

The first aspect of the present invention provides the porous tin foil anode, wherein the plurality of holes provide sufficient reserved space for the volume change caused by the formation of the tin-sodium alloy as a result of the intercalation of sodium ions into the tin foil to avoid the problem of anode expansion, thus solving the battery expansion problem. A certain distance is reserved at the edge of the porous tin foil anode without arranging holes, which can effectively prevent the formation of rough edges and burrs and improve the stability and safety of the battery. The carbon material layer is arranged on the surface of the porous tin foil, so that the electrolyte forms a stable solid electrolyte membrane on the surface of the porous tin foil anode during the charge and discharge process of the battery, which effectively alleviates the problem that the solid electrolyte membrane is destroyed and decomposed during the charge and discharge process of the battery, thereby further improving the charge and discharge efficiency and cycle and safety performances of the battery.

The second aspect of the present invention provides a method for preparing the porous tin foil anode, including the following steps:

preparing the porous tin foil by at least one processing method selected from the group consisting of mechanical molding, chemical etching, laser cutting, plasma etching and electrochemical etching to obtain the porous tin foil anode; wherein a plurality of holes are uniformly formed in the porous tin foil; a triangular area formed by lines connecting centers of three adjacent holes is used as a smallest unit; the proportion of the area of the holes in each smallest unit is 1%-89%; and the distance between the edge of the porous tin foil and the outermost hole is 0.1 mm-10 mm.

The porous tin foil can be prepared based on the model of the battery or the battery capacity design requirements, and the surface density of the cathode is designed in combination with factors, such as cathode material type, specific capacity and compaction density. Then, the porosity and size (including length, width, and thickness) of the battery anode are designed according to the tin-sodium alloy material formed by the sodium ions and the tin foil and a specific capacity of 225.76 mAh/g. After that, the size, shape and hole distribution of the porous tin foil are designed according to the porosity and size (including length, width, and thickness) of the battery anode. Finally, the porous tin foil is jointly manufactured by at least one processing method selected from the group consisting of mechanical molding, chemical etching, laser cutting, plasma etching and electrochemical etching in combination with the above-mentioned design solution. Any resulting burrs are purged and removed with compressed air.

In the present invention, an isosceles triangular area formed by lines connecting the centers of three adjacent holes in two adjacent rows in the porous tin foil is used as the smallest unit. Each smallest unit has an equal proportion of the area of the holes. Further, optionally, any two adjacent holes in the horizontal direction have an equal distance, and any two adjacent holes in the vertical direction have an equal distance.

Optionally, the distance between any two adjacent holes in the horizontal direction is equal to the distance between any two adjacent holes in the vertical direction. Optionally, the distance between any two adjacent holes in the horizontal direction is equal to the distance between two adjacent rows.

Optionally, the size of the holes of the porous tin foil is 20 nm-2 mm. Further, the size of the holes of the porous tin foil is 50 μm-1.5 mm. Further, preferably, the holes have an equal size.

In the present invention, the shape of the plurality of holes of the porous tin foil can be one selected from the group consisting of a circle, an oval, a square, a rectangle, a rhombus, a triangle, a polygon, a pentagram and a quincunx. It should be understood that the shape is not limited to the above shapes.

Further, optionally, the proportion of the area of the holes in each smallest unit 25%-60%.

Further, optionally, the distance between the edge of the porous tin foil and the outermost hole is 2 mm-5 mm. In this way, when the large-sized porous tin foil obtained by mechanical processing is cut into electrodes, the burrs are prevented from generating on the edge of the tin foil caused by the damage to the hole.

Optionally, the thickness of the porous tin foil is 10-100 μm.

Optionally, a carbon material layer is prepared on the porous tin foil by the following steps: coating a solution containing a carbon material on the surface of the porous tin foil and drying the porous tin foil to obtain the porous tin foil anode. The porous tin foil anode includes the porous tin foil and the carbon material layer arranged on the surface of the porous tin foil.

Optionally, the material of the carbon material layer includes at least one selected from the group consisting of hard carbon, soft carbon, conductive carbon black, graphene, a graphite flake and a carbon nanotube. The thickness of the carbon material layer is 2 nm-5 μm. Further, the thickness of the carbon material layer is 200 nm-3 μm.

The inert gas is argon, nitrogen or the like. The reducing gas can be hydrogen. The porous tin foil is dried for 2-6 hours at 80° C-100° C.

The second aspect of the present invention provides the method of preparing the porous tin foil anode, which has a simple process, low cost and is easy to achieve industrial production. The prepared porous tin foil anode has stable performance.

The third aspect of the present invention provides a sodium ion secondary battery that includes a cathode, an electrolyte, a separator and an anode. The anode is the porous tin foil anode in the first aspect of the present invention. The porous tin foil anode includes porous tin foil. A plurality of holes are uniformly formed on the porous tin foil. A triangular area formed by lines connecting centers of three adjacent holes is used as a smallest unit. The proportion of the area of the holes in each smallest unit is 1%-89%. The distance between the edge of the porous tin foil and the outermost hole is 0.1 mm-10 mm. The porous tin foil acts as both the current collector and the anode active material in the porous tin foil anode.

In the sodium ion secondary battery of the present invention, the proportion of the area of the porous tin foil acting as the current collector in each smallest unit is 10%-70%, and the proportion of the area of the porous tin foil acting as the anode active material in each smallest unit is 1%-51%.

Further, optionally, the proportion of the area of the holes in each smallest unit is 25%-60%.

Further, optionally, the distance between the edge of the porous tin foil and the outermost hole is 2 mm-5 mm.

In the present invention, an isosceles triangular area formed by lines connecting the centers of three adjacent holes in two adjacent rows in the porous tin foil is used as the smallest unit. Each smallest unit has an equal proportion of the area of the holes. Further, optionally, any two adjacent holes in the horizontal direction have an equal distance, and any two adjacent holes in the vertical direction have an equal distance.

Optionally, the distance between any two adjacent holes in the horizontal direction is equal to the distance between any two adjacent holes in the vertical direction. Optionally, the distance between any two adjacent holes in the horizontal direction is equal to the distance between two adjacent rows.

Optionally, the size of the holes of the porous tin foil is 20 nm-2 mm. Further, the size of the holes of the porous tin foil is 50 μm-1.5 mm. Further, preferably, the holes have an equal size.

In the present invention, the shape of the plurality of holes of the porous tin foil can be one selected from the group consisting of a circle, an oval, a square, a rectangle, a rhombus, a triangle, a polygon, a pentagram and a quincunx. It should be understood that the shape is not limited to the above shapes.

In the present invention, the surface of the porous tin foil is provided with a carbon material layer. Optionally, the material of the carbon material layer includes at least one selected from the group consisting of hard carbon, soft carbon, conductive carbon black, graphene, a graphite flake and a carbon nanotube. The thickness of the carbon material layer is 2 nm-5 μm. Further, the thickness of the carbon material layer is 200 nm-3 μm.

In the present invention, the cathode includes a cathode active material, wherein the cathode active material is a graphite cathode material or a sodium ion cathode material, e.g., NaxCoO₂, Na₂Fe₂(SO₄)₃, Na₃V₂(PO₄)₃, and NAxNi_{0.22}Co_{0.11}Mn_{0.6602}. Namely, the sodium ion secondary battery can be a conventional sodium ion battery or a tin-graphite dual-ion battery. When the sodium ion secondary battery is a tin-graphite dual-ion battery, the cathode includes graphite, namely, the graphite is used as the cathode active material.

The electrolyte and the separator are commonly used in sodium ion batteries and available in the prior art. For example, the electrolyte can be 1 mol/L NaPF₆ in ethylene carbonate (EC)+ethyl methyl carbonate (EMC) (in a volume ratio of 1:1) or 1 mol/L NaClO₄ in EC+EMC (in a volume ratio of 1:1) or the like. The separator is a polypropylene membrane or a glass fiber membrane or the like.

The third aspect of the present invention provides the sodium ion secondary battery, wherein the porous tin foil with a specific hole arrangement is used as both the current collector and the anode active material, which has good cycle performance and high safety performance.

The advantages of the present invention will be partially described in the following description, wherein a part of these advantages is obvious from the description, or may be obtained through the implementation of the embodiments of the present invention.

### BRIEF DESCRIPTION OF THE DRAWINGS

FIG. 1 is a schematic diagram showing the structure of the porous tin foil according to embodiment 1 of the present invention.

FIG. 2 is a schematic diagram showing the structure of the porous tin foil according to embodiment 2 of the present invention.

FIG. 3 is a schematic diagram showing the structure of the porous tin foil according to embodiment 26 of the present invention.

### DETAILED DESCRIPTION OF THE EMBODIMENTS

The preferred embodiments of the present invention are described hereinafter. It should be noted that those having ordinary skill in the art can make several improvements and modifications without departing from the principles of the embodiments of the present invention, and these improvements and modifications shall fall within the scope of protection of the embodiments of the present invention.

The embodiments of the present invention are further described hereinafter, but not limited to the following specific embodiments. The present invention can be appropriately modified and implemented without changing the scope of the main claims of the present invention.

### Embodiment 1

A method for preparing the porous tin foil anode includes the following steps.

(1) The porous tin foil is prepared by performing mechanical molding on a tin foil with a thickness of 20 μm according to the design parameters that a proportion of the area of the holes in each smallest unit is 25%, the size is 1 mm, the shape of the hole is a circle, and the distance between the edge of the outermost hole and the edge of the tin foil is 2 mm. Any resulting burrs are purged and removed with compressed air.

(2) An aqueous solution containing 1 wt % acetylene black is coated on the prepared porous tin foil mentioned above, and then the porous tin foil is dried at a constant temperature of 100° C. for 4 hours to obtain the porous tin foil anode.

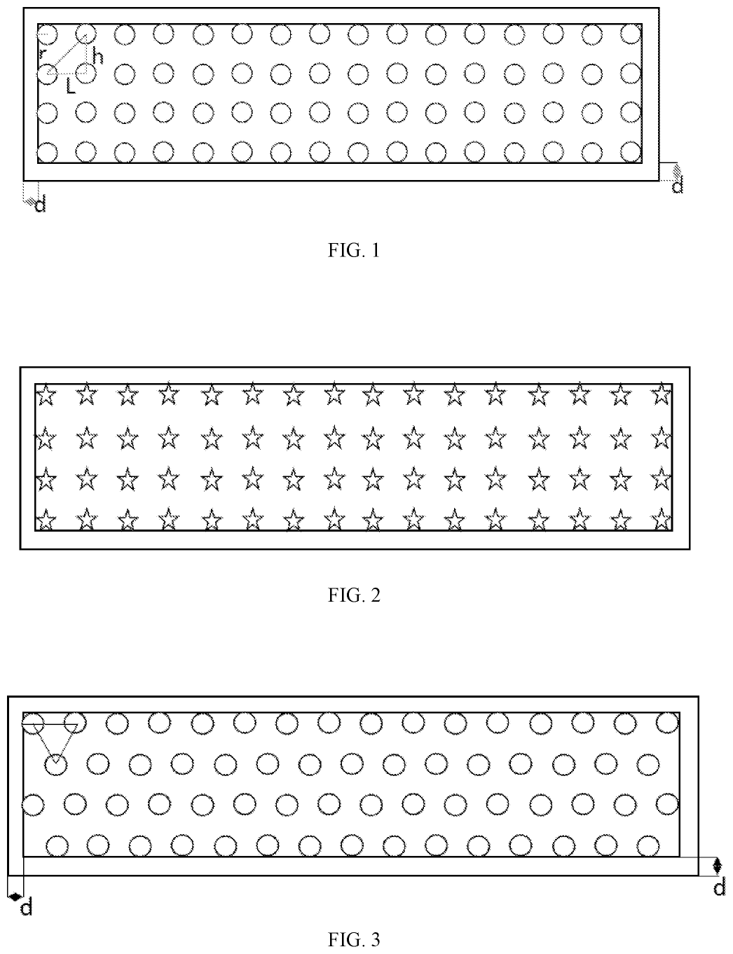

FIG. 1 is a schematic diagram showing the structure of the porous tin foil according to embodiment 1 of the present invention; wherein d represents the distance (4 mm) from the edge of the outermost hole to the edge of the tin foil, and r represents the radius of the circular hole. An isosceles triangular area formed by lines connecting the centers of three adjacent holes is used as the smallest unit. In the smallest unit, the proportion of the area (πr²)/2 of the holes in the total area (h*L)/2 of the triangular area is 25%.

In the present embodiment, the plurality of holes are arranged in a rectangular array with an equal distance between any two adjacent holes in the horizontal direction and an equal distance between any two adjacent holes in the vertical direction, and the distance between any two adjacent holes in the horizontal direction is equal to the distance between any two adjacent holes in the horizontal direction. Each horizontal row has an equal number of holes, and each vertical row has an equal number of holes. The holes are aligned and have an equal size.

Preparation of the Tin-Graphite Dual-Ion Battery

A graphite cathode material with a specific capacity of 100 mAh/g, polyvinylidene difluoride (PVDF) and conductive carbon black in a mass ratio of 95:3:2 are coated on the tin foil to form the cathode. The processing technology and process control of the cathode adopt the current industrial process technology. Finally, the porous tin foil anode prepared in the embodiment of the present invention, the cathode, an electrolyte and a separator are encapsulated in a glove box filled with argon to obtain the entire battery and battery sample C10, wherein the electrolyte is 4 mol/L NaPF₆ in a mixed solution of EC, dimethyl carbonate (DMC) and EMC (in a volume ratio of 1:1:1) and the separator is a celgard2400 polypropylene porous membrane.

Preparation of the Conventional Sodium Ion Battery

Na₂Fe₂(SO₄)₃ cathode material with a specific capacity of 100 mAh/g, PVDF, conductive carbon black in a mass ratio of 95:3:2 are coated on the aluminum foil to form the cathode. The processing technology and process control of the cathode adopt the current industrial process technology. Finally, the porous tin foil anode prepared in the embodiment of the present invention, the cathode, an electrolyte, and a separator are encapsulated in a glove box filled with argon to obtain the entire battery and battery sample C20, wherein the electrolyte is 4 mol/L NaPF₆ in a mixed solution of EC, DMC and EMC (in a volume ratio of 1:1:1), and the separator is a celgard2400 polypropylene porous membrane.

Comparative Embodiment 1 (Tin-Graphite Dual-Ion Battery)

The tin foil with a thickness of 20 μm is used as the anode. The graphite cathode material with a specific capacity of 100 mAh/g, PVDF and conductive carbon black in a mass ratio of 95:3:2 are coated on the tin foil to form the cathode. Then, the cathode, the tin foil anode, an electrolyte, and a separator are encapsulated in a glove box filled with argon to obtain the entire battery and battery sample C00, wherein the electrolyte is 4 mol/L LiPF6 in a mixed solution of EC, DMC and EMC (in a volume ratio of 1:1:1), and the separator is a celgard2400 polypropylene porous membrane.

### Embodiments 2-25

With reference to the specific steps of embodiment 1, the related parameters can be adjusted to obtain different embodiments 2-25. The parameters of the specific embodiments and test results are shown in Table 1:

TABLE 1

| | | | Proportion | Proportion | Proportion | |
|---|---|---|---|---|---|---|
| | | | (%) of the | (%) of the | (%) of the | |
| | | | area of the | anode active | anode current | |
| | | Hole | holes in the | material in the | collector in the | Coating |
| Number | Cathode type | size (mm) | smallest unit | smallest unit | smallest unit | material |
| Embodiment 1 | graphite | 1 | 25 | 25 | 50 | 1% acetylene |
| | | | | | | black |
| Embodiment 2 | graphite | 2 | 30 | 30 | 40 | 1% conductive |
| | | | | | | carbon black |
| Embodiment 3 | graphite | 1 | 25 | 25 | 50 | [symbol] |
| Embodiment 4 | graphite | 2 | 25 | 32.5 | 42.5 | 1% graphite |
| | | | | | | flake |
| Embodiment 5 | graphite | 2 | 25 | 32.5 | 42.5 | 1% S-p |
| Embodiment 6 | graphite | 0.2 | 32.5 | 32.5 | 35 | 1% hard carbon |
| Embodiment 7 | graphite | 0.8 | 25 | 35 | 45 | 2% conductive |
| | | | | | | carbon black |
| Embodiment 8 | graphite | 0.5 | 89 | 1 | 10 | 2% soft carbon |
| Embodiment 9 | graphite | 0.3 | 79 | 1 | 20 | 2% acetylene |
| | | | | | | black |
| Embodiment 10 | graphite | 0.5 | 70 | 10 | 20 | 2% conductive |
| | | | | | | carbon black |
| Embodiment 11 | Na [symbol] Nl [symbol] Co [symbol] Mn [symbol] | 1.5 | 65 | 15 | 20 | 2% graphene |
| Embodiment 12 | Na [symbol] V [symbol] (PO [symbol] ) [symbol] | 1.2 | 60 | 20 | 20 | 2% graphite |
| | | | | | | flake |
| Embodiment 13 | Na [symbol] Fe [symbol] (SO [symbol] ) [symbol] | 1.5 | 55 | 25 | 20 | 2% S-p |
| Embodiment 14 | Na [symbol] CoO [symbol] | 1.2 | 45 | 35 | 20 | 2% hard carbon |
| Embodiment 15 | graphite | 0.00002 | 10 | 40 | 50 | 2% conductive |
| | | | | | | carbon black |
| Embodiment 16 | graphite | 0.0002 | 19 | 51 | 30 | 3% soft carbon |
| Embodiment 17 | graphite | 0.001 | 15 | 51 | 34 | 3% acetylene |
| | | | | | | black |
| Embodiment 18 | graphite | 0.005 | 40 | 40 | 20 | 3% conductive |
| | | | | | | carbon black |
| Embodiment 19 | graphite | 0.05 | 50 | 30 | 20 | 3% graphene |
| Embodiment 20 | graphite | 0.01 | 15 | 45 | 40 | 3% graphite |
| | | | | | | flake |
| Embodiment 21 | graphite | 0.00005 | 10 | 30 | 60 | 3% S-p |
| Embodiment 22 | graphite | 0.002 | 20 | 35 | 45 | 3% hard carbon |
| Embodiment 23 | graphite | 0.001 | 30 | 45 | 25 | 3% conductive |
| | | | | | | carbon black |
| Embodiment 24 | graphite | 0.02 | 40 | 40 | 20 | 3% graphene |
| Embodiment 25 | graphite | 0.05 | 10 | 20 | 70 | 3% graphite |
| | | | | | | flake |
| Comparative | graphite | 0 | 0 | 25 | 75 | 0 |
| Embodiment 1 | | | | | | |

| | | | | | 500-cycle |
|---|---|---|---|---|---|
| | | | Distance (mm) | Battery | battery |
| | Tin foil | | between hole | first | capacity |
| | thickness | | edge and | efficiency | retention |
| Number | (μm) | Hole shape | electrode edge | (%) | rate (%) |
| Embodiment 1 | 20 | circle | 4 | 85 | 86.5 |
| Embodiment 2 | 45 | pentagram | 3 | 84 | 85 |
| Embodiment 3 | 35 | rhomboid | 3 | 83.5 | 84.5 |
| Embodiment 4 | 25 | pentagram | 3 | 85 | 85 |
| Embodiment 5 | 20 | circle | 3 | 85 | 85 |
| Embodiment 6 | 90 | pentagram | 4 | 84.5 | 86 |
| Embodiment 7 | 80 | square | 2 | 86 | 86 |
| Embodiment 8 | 25 | square | 2 | 84.5 | 94.5 |
| Embodiment 9 | 40 | square | 2 | 85 | 95 |
| Embodiment 10 | 30 | regular hexagon | 2 | 86 | 91 |
| Embodiment 11 | 40 | regular pentagon | 2 | 89 | 91 |
| Embodiment 12 | 20 | circle | 3 | 89.5 | 91 |
| Embodiment 13 | 40 | regular pentagon | 2 | 87 | 90.5 |
| Embodiment 14 | 20 | circle | 3 | 88 | 90.5 |
| Embodiment 15 | 70 | rhombus | 0.1 | 88.5 | 88.5 |
| Embodiment 16 | 25 | rhombus | 0.5 | 88 | 89 |
| Embodiment 17 | 16 | rhombus | 1 | 87.5 | 87.5 |
| Embodiment 18 | 40 | rhombus | 0.5 | 87 | 88 |
| Embodiment 19 | 50 | rhombus | 0.5 | 86.5 | 89 |
| Embodiment 20 | 100 | rhombus | 2 | 88 | 87 |
| Embodiment 21 | 60 | circle | 4 | 89 | 88 |
| Embodiment 22 | 30 | circle | 2 | 88.5 | 88.5 |
| Embodiment 23 | 75 | circle | 5 | 88 | 87 |
| Embodiment 24 | 40 | circle | 3 | 86.5 | 86 |
| Embodiment 25 | 50 | circle | 1 | 89 | 92 |
| Comparative | 50 | [symbol] | 0 | 65 | 80 |
| Embodiment 1 | | | | | |

[symbol]

indicates data missing or illegible when filed

### Embodiment 26

A Method for Preparing the Porous Tin Foil Anode Includes the Following Steps:

(1) The porous tin foil is prepared by performing mechanical molding on a tin foil with a thickness of 20 μm according to the design parameters that a proportion of the area of the holes in each smallest unit is 25%, the size is 1 mm, the shape of the hole is a circle and the distance between the edge of the outermost hole and the edge of the tin foil is 2 mm. Any resulting burrs are purged and removed with compressed air.

(2) An aqueous solution containing 1 wt % acetylene black is coated on the prepared porous tin foil mentioned above, and then, the porous tin foil is dried at a constant temperature of 100° C. for 4 hours to obtain the porous tin foil anode.

FIG. 3 is a schematic diagram showing the structure of the porous tin foil according to embodiment 26 of the present invention; wherein d represents the distance (2 mm) from the edge of the outermost hole to the edge of the tin foil, and r represents the radius of the circular hole. An isosceles triangular area formed by lines connecting the centers of three adjacent holes in two adjacent rows is used as the smallest unit. In each smallest unit, the proportion of the area (πr²)/2 of the holes in the total area of the triangular area is 25%. In the present embodiment, any two adjacent holes in the horizontal direction have an equal distance, and any two adjacent holes in the vertical direction have an equal distance. The distance between any two adjacent holes in the horizontal direction is equal to the distance between two adjacent rows. In other embodiments, the distance between any two adjacent holes in the horizontal direction may be not equal to the distance between two adjacent rows. Each odd-numbered horizontal row or vertical row has an equal number of holes, and each even-numbered horizontal row or vertical row has an equal number of holes. The holes of each odd-numbered horizontal row or even-numbered horizontal row are aligned and have an equal size.

It should be noted that those skilled in the art can make several changes and modifications to the foregoing embodiments of the present invention according to the teachings and description of the above specification. Therefore, the present invention is not limited to the specific embodiments disclosed and described above, and some equivalent modifications and changes to the present invention shall fall within the scope of protection of the claims of the present invention. In addition, although certain terminologies are used in the specification, these terminologies are only intended to facilitate the description and cannot be construed as any limitation on the present invention.

What is claimed is:

1. A porous tin foil anode, comprising a porous tin foil;
wherein
a plurality of holes are uniformly formed on the porous tin foil; a triangular area formed by lines connecting centers of three adjacent holes of the plurality of holes is used as a first smallest unit; a proportion of an area of the three adjacent holes in each first smallest unit is 1%-89%; a distance between an edge of the porous tin foil and an outermost hole of the plurality of holes is 0.1 mm-10 mm.

2. The porous tin foil anode according to claim 1, wherein, an isosceles triangular area formed by lines connecting centers of three adjacent holes in two adjacent horizontal rows in the plurality of holes is used as a second smallest unit, and each second smallest unit has an equal proportion of an area of the three adjacent holes in the two adjacent horizontal rows.

3. The porous tin foil anode according to claim 2, wherein, two adjacent holes of the plurality of holes in a horizontal direction have an equal distance, and two adjacent holes of the plurality of holes in a vertical direction have an equal distance.

4. The porous tin foil anode according to claim 3, wherein, a distance between the two adjacent holes in the horizontal direction is equal to a distance between the two adjacent holes in the vertical direction.

5. The porous tin foil anode according to claim 3, wherein, a distance between the two adjacent holes in the horizontal direction is equal to a distance between the two adjacent horizontal rows.

6. The porous tin foil anode according to claim 1, wherein, the plurality of holes have an equal size.

7. The porous tin foil anode according to claim 1, wherein, the proportion of the area of the three adjacent holes in the each first smallest unit is 25%-60%.

8. The porous tin foil anode according to claim 1, wherein, the distance between the edge of the porous tin foil and the outermost hole is 2 mm-5 mm.

9. The porous tin foil anode according to claim 1, wherein, a size of each hole of the plurality of holes is 20 nm-2 mm; and a shape of the each hole is one selected from the group consisting of a circle, an oval, a square, a rectangle, a rhombus, a triangle, a polygon, a pentagram, and a quincunx.

10. The porous tin foil anode according to claim 1, wherein, a surface of the porous tin foil is provided with a carbon material layer, and a thickness of the carbon material layer is 2 nm-5 μm.

11. The porous tin foil anode according to claim 10, wherein, a material of the carbon material layer is at least one selected from the group consisting of a hard carbon, a soft carbon, a conductive carbon black, a graphene, a graphite flake and a carbon nanotube.

12. A method for preparing a porous tin foil anode, comprising the following steps:
preparing a porous tin foil by performing mechanical molding on a tin foil with a thickness of 20 μm, according to parameters; wherein a plurality of holes are uniformly formed on the porous tin foil; a triangular area formed by lines connecting centers of three adjacent holes of the plurality of holes is used as a smallest unit; a proportion of an area of the three adjacent holes in each smallest unit is 1%-89%; and a distance between an edge of the porous tin foil and an outermost hole of the plurality of holes is 0.1 mm-10 mm; the parameters are designed by the proportion of the area of the three adjacent holes in each smallest unit, a size of each hole of the plurality of holes, a shape of the each hole and the distance between the edge of the porous tin foil and the outermost hole of the plurality of holes; and
coating an aqueous solution containing 1 wt % acetylene black on the porous tin foil, and drying the porous tin foil at a constant temperature of 100° C. for 4 hours to obtain the porous tin foil anode.

13. The method for preparing the porous tin foil anode according to claim 12, wherein, a carbon material layer is prepared on the porous tin foil by the following steps:
coating a solution containing a carbon material on a surface of the porous tin foil, and drying the porous tin foil to obtain the porous tin foil anode.

14. A sodium ion secondary battery, comprising: a cathode, an electrolyte, a separator, and an anode;
wherein
the anode is a porous tin foil anode; the porous tin foil anode comprises a porous tin foil; a plurality of holes are uniformly formed on the porous tin foil; a triangular area formed by lines connecting centers of three adjacent holes of the plurality of holes is used as a first smallest unit; a proportion of an area of the three adjacent holes in each first smallest unit is 1%-89%; a distance between an edge of the porous tin foil and an outermost hole of the plurality of holes is 0.1 mm-10 mm; and the porous tin foil of the porous tin foil anode acts as both a current collector and an anode active material.

15. The sodium ion secondary battery according to claim 14, wherein, an isosceles triangular area formed by lines connecting centers of three adjacent holes in two adjacent horizontal rows in the plurality of holes is used as a second smallest unit, and each second smallest unit has an equal proportion of an area of the three adjacent holes in the two adjacent horizontal rows.

16. The sodium ion secondary battery according to claim 15, wherein, two adjacent holes of the plurality of holes in a horizontal direction have an equal distance, and two adjacent holes of the plurality of holes in a vertical direction have an equal distance; a distance between the two adjacent holes in the horizontal direction is equal to a distance between the two adjacent holes in the vertical direction; and the distance between the two adjacent holes in the horizontal direction is equal to a distance between the two adjacent horizontal rows.

17. (canceled)

18. (canceled)

19. The sodium ion secondary battery according to claim 14, wherein, the plurality of holes have an equal size.

20. The sodium ion secondary battery according to claim 14, wherein, a size of each hole of the plurality of holes is 20 nm-2 mm; and a shape of the each hole is one selected from the group consisting of a circle, an oval, a square, a rectangle, a rhombus, a triangle, a polygon, a pentagram, and a quincunx.

21. The sodium ion secondary battery according to claim 14, wherein, a surface of the porous tin foil is provided with a carbon material layer, and a thickness of the carbon material layer is 2 nm-5 μm.

22. The sodium ion secondary battery according to claim 14, wherein, a proportion of an area of the porous tin foil acting as the current collector in the each first smallest unit is 10%-70%, and a proportion of an area of the porous tin foil acting as the anode active material in the each first smallest unit is 1%-51%.
